(19) United States
(12) Patent Application Publication
(10) Pub. No.: US 2026/0316600 A1
(43) Pub. Date: Oct. 15, 2026

(54) CONFIGURATION AND CONTROL METHODS FOR POWER CONVERSION SYSTMES IN HYDROGEN LOCOMOTIVES

(71) Applicant: KOREA RAILROAD RESEARCH INSTITUTE, Uiwang-si (KR)

(72) Inventors: Jin Hyuk PARK, Seongnam-si (KR); June Hee LEE, Suwon-si (KR); Joon Hyung RYU, Gunpo-si (KR)

(21) Appl. No.: 19/467,128

(22) Filed: Feb. 2, 2026

Related U.S. Application Data
(63) Continuation of application No. PCT/KR2025/018714, filed on Nov. 13, 2025.

(30) Foreign Application Priority Data
Nov. 13, 2024 (KR) 10-2024-0161326

(51) Int. Cl. B60L 50/75; B60L 7/16; B60L 58/40; H02M 3/335

(52) U.S. Cl. CPC B60L 50/75; B60L 7/16; B60L 58/40; H02M 3/33573; H02M 3/33592; B60L 2200/26; B60L 2210/10

(57) ABSTRACT

Embodiments relate to a configuration and a control method of a power conversion apparatus for a hydrogen fuel cell of a hydrogen locomotive. The power conversion apparatus for a hydrogen fuel cell of a hydrogen locomotive according to one embodiment includes a TAB (Triple-Active-Bridge) converter, and is characterized in that a hydrogen fuel cell and a battery are electrically isolated.

### CROSS-REFERENCE TO RELATED APPLICATION

This application is a continuation of International Application No. PCT/KR2025/018714 filed on Nov. 13, 2025, which claims priority to Korean Patent Application No. 10-2024-0161326, filed on Nov. 13, 2024, in the Korean Intellectual Property Office, the disclosure of which is incorporated by reference herein in its entirety.

### BACKGROUND

### Technical Field

The present invention relates to a configuration and a control method of a power conversion apparatus for a hydrogen fuel cell of a hydrogen locomotive.

### Background Art

According to the related art, a hydrogen railway vehicle includes a hydrogen fuel cell, a battery, a DC/DC converter for the hydrogen fuel cell, a propulsion DC/DC converter, a propulsion inverter, and a motor, and FIG. 1 illustrates a connection diagram of main devices of the hydrogen railway vehicle.

Since an output voltage of the fuel cell is low and voltage fluctuation is large, a DC/DC converter is used for stable voltage supply, and a non-isolated DC/DC converter is mainly used in consideration of a simple structure and ease of control. The battery is used to compensate for insufficient dynamic characteristics of the hydrogen fuel cell and to store regenerative power of the railway vehicle. Power of the hydrogen fuel cell and the battery is boosted through the propulsion DC/DC converter and supplies an appropriate DC voltage to the propulsion inverter.

As a high-power device, a railway vehicle propulsion system inevitably uses parallel connection of hydrogen fuel cells to output power of several hundred kW to several MW. When the hydrogen fuel cell and the non-isolated DC/DC converter are used independently, there is no particular problem, however, when the hydrogen fuel cell and the non-isolated DC/DC converter are used by being connected in parallel, the hydrogen fuel cell and the DC/DC converter have a common ground (ground), thereby reducing insulation resistance of the hydrogen fuel cell. Due to such a reduction in insulation resistance, problems such as electric shock, fire, degradation of system performance, and damage to electronic components may occur.

In addition, in a railway vehicle design environment with space constraints, use of a lithium-ion battery having high power density is required for long-distance operation, however, the lithium-ion battery has risks of fire and safety accidents, and thus electrical insulation from other electrical components should be considered.

### SUMMARY

### Problem to be Solved

The present invention has been proposed based on the above-described background, and an object thereof is to provide a configuration and a control method of a power conversion apparatus for a hydrogen fuel cell of a hydrogen locomotive, which is capable of improving system reliability by electrically isolating both a hydrogen fuel cell and a battery.

### Means for Solving the Problem

A power conversion apparatus for a hydrogen fuel cell of a hydrogen locomotive according to the present invention includes a TAB (Triple-Active-Bridge) converter, and is characterized in that the hydrogen fuel cell and the battery are electrically isolated.

The TAB converter includes a bridge between the hydrogen fuel cell and a propulsion DC/DC converter (a second bridge), and a bridge between the battery and the propulsion DC/DC converter (a third bridge).

The TAB converter transfers power between bridges based on a phase difference between a phase of the second bridge and a phase of the third bridge, with reference to a phase of a reference bridge connected to the propulsion DC/DC converter.

A control method of a power conversion apparatus for a hydrogen fuel cell of a hydrogen locomotive, which is performed by a power conversion control system for a hydrogen fuel cell of a hydrogen locomotive according to the present invention, includes: (a) configuring a power conversion apparatus for a hydrogen fuel cell of a hydrogen locomotive including a TAB converter; and (b) controlling the power conversion apparatus to transfer power during propulsion operation or regenerative operation.

The step (a) configures the TAB converter including a bridge between the hydrogen fuel cell and the propulsion DC/DC converter, and a bridge between the battery and the propulsion DC/DC converter.

The step (b) outputs a current command of the propulsion DC/DC converter, converts the current command into a power command, determines a power command of the hydrogen fuel cell based on a V-I curve of the hydrogen fuel cell and railway vehicle operating conditions, determines a difference between the power command of the propulsion DC/DC converter and the power command of the hydrogen fuel cell as a power command of the battery, and outputs phase commands of the bridge between the hydrogen fuel cell and the propulsion DC/DC converter and the bridge between the battery and the propulsion DC/DC converter.

In the step (b), during a propulsion operation in which only the hydrogen fuel cell generates power, the battery does not perform charging or discharging.

In the step (b), during a propulsion operation in which only the battery generates power, power is supplied to the propulsion DC/DC converter through C-rate adjustment of the battery.

In the step (b), during a propulsion operation in which power of the propulsion DC/DC converter is less than rated power of the hydrogen fuel cell, the hydrogen fuel cell charges the battery with remaining power after transferring power to the propulsion DC/DC converter.

In the step (b), during the regenerative operation, regenerative power of the DC/DC converter is entirely transferred to the battery.

### Effects of the Invention

According to the present invention, it is possible to improve system reliability by electrically isolating both the hydrogen fuel cell and the battery, and it can be confirmed that control is performed under railway vehicle operating conditions.

The effects of the present invention are not limited to those described above, and other effects not described above will be clearly understood by those skilled in the art from the following description.

### BRIEF DESCRIPTION OF THE DRAWINGS

FIG. 1 is a diagram illustrating a connection of main devices of a hydrogen railway vehicle.

FIG. 2 illustrates a power conversion apparatus for a hydrogen fuel cell of a hydrogen locomotive according to an embodiment of the present invention.

FIG. 3 illustrates a control algorithm of a power conversion apparatus for a hydrogen fuel cell of a hydrogen locomotive according to an embodiment of the present invention.

FIG. 4 illustrates a control method of a power conversion apparatus for a hydrogen fuel cell of a hydrogen locomotive according to an embodiment of the present invention.

FIG. 5 illustrates simulation results of a propulsion operation (hydrogen fuel cell and battery power generation) according to an embodiment of the present invention.

FIG. 6 illustrates simulation results of a propulsion operation (hydrogen fuel cell power generation only) according to an embodiment of the present invention.

FIG. 7 illustrates simulation results of a propulsion operation (battery power generation only) according to an embodiment of the present invention.

FIG. 8 illustrates simulation results of a propulsion operation (hydrogen fuel cell power generation and battery charging) according to an embodiment of the present invention.

FIG. 9 illustrates simulation results of a regenerative operation (battery charging only) according to an embodiment of the present invention.

FIG. 10 is a block diagram illustrating a computer system for implementing a method according to an embodiment of the present invention.

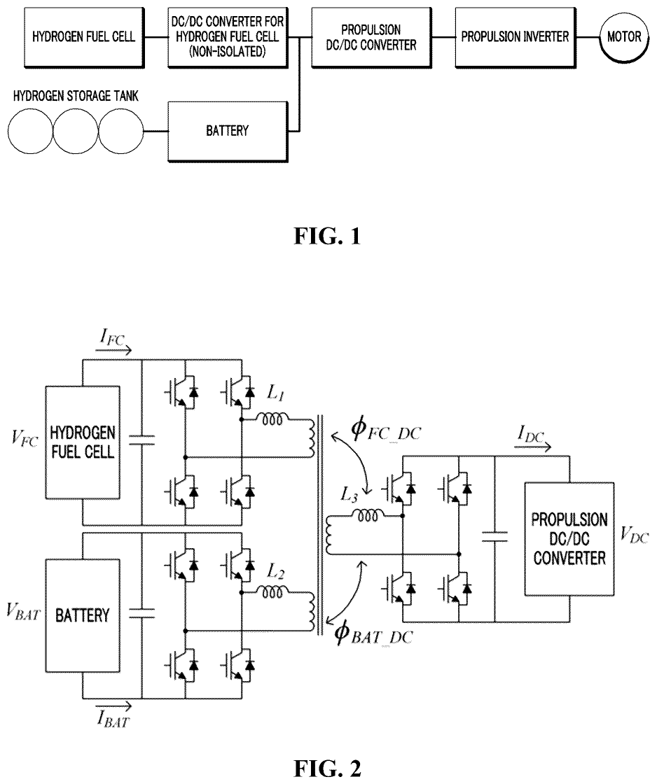

### DETAILED DESCRIPTION OF CARRYING OUT THE INVENTION

The above-described objects and other objects, advantages, and features of the present invention, and methods for achieving the same, will become apparent with reference to embodiments described below in detail in conjunction with the accompanying drawings.

However, the present invention is not limited to the embodiments disclosed below and may be implemented in various different forms, and the following embodiments are provided only to easily inform those skilled in the art of the objects, configurations, and effects of the present invention, and the scope of the present invention is defined by the matters described in the claims.

Meanwhile, terms used in the present specification are for describing the embodiments and are not intended to limit the present invention. In the present specification, a singular form includes a plural form unless otherwise specified in the context. As used herein, the terms “comprises” and/or “comprising” do not exclude the presence or addition of one or more other components, steps, operations, and/or elements in addition to the stated components, steps, operations, and/or elements.

Hereinafter, a background in which the present invention has been proposed will be described to aid understanding of those skilled in the art, and embodiments of the present invention will be described.

A hydrogen fuel cell-based railway vehicle propulsion system is a high-power apparatus and requires the use of multiple fuel cells connected in parallel. In general, an output voltage of a hydrogen fuel cell is low and voltage fluctuation is large, and thus a DC/DC converter is used to output a stable voltage. In order to match output power, a propulsion system of a hydrogen locomotive inevitably uses a plurality of hydrogen fuel cells connected in parallel, and when the hydrogen fuel cells and the DC/DC converters are connected in parallel, the hydrogen fuel cells and the DC/DC converters share a common ground, thereby reducing insulation resistance of the hydrogen fuel cells. Accordingly, problems such as risk of electric shock, risk of fire, degradation of system performance, and damage to electronic components may occur.

In order to ensure system reliability, when hydrogen fuel cells are used in parallel, an isolated DC/DC converter should be used, and when the isolated DC/DC converter is used, grounds of the hydrogen fuel cells and the DC/DC converters are separated, thereby preventing a reduction in insulation resistance of the hydrogen fuel cells.

Since a hydrogen fuel cell is capable of power generation only, a hydrogen fuel cell-based railway vehicle propulsion system uses both a hydrogen fuel cell and a battery in consideration of railway vehicle operating efficiency, and when a lithium-ion battery having high power density is used in consideration of space and long-distance operation of a railway vehicle, there is a risk of fire and safety accidents, and thus a DC/DC converter capable of electrical isolation should be used to ensure system stability.

According to an embodiment of the present invention, a power conversion apparatus for a hydrogen fuel cell of a hydrogen locomotive including a TAB (Triple-Active-Bridge) converter and a control method thereof are proposed, thereby providing an advantage in that the hydrogen fuel cell and the battery can be electrically isolated from each other.

FIG. 2 illustrates a power conversion apparatus for a hydrogen fuel cell of a hydrogen locomotive according to an embodiment of the present invention.

The power conversion apparatus for a hydrogen fuel cell of a hydrogen locomotive according to an embodiment of the present invention uses a TAB converter. The TAB converter is a power conversion structure mainly used in high-voltage and high-power applications. The TAB converter has a structure in which three H-bridges are connected to a transformer, and each H-bridge generates an alternating voltage through high-frequency switching, thereby converting voltage through the transformer. Switching operations of each bridge are controllable by a relative phase difference, and by adjusting the phase difference, desired output voltage and current can be obtained, and power flow can be adjusted according to load conditions.

The TAB has a structure in which three H-bridges are connected to a high-frequency transformer having three windings, and thus it is possible to electrically isolate all three electrical components connected to the H-bridges. Accordingly, even when hydrogen fuel cells are connected in parallel, insulation resistance is not reduced, and the battery is also electrically isolated from other electrical components, thereby making it possible to improve system reliability.

Referring to FIG. 2, the TAB converter includes three bridges, and when a phase of a bridge connected to the propulsion DC/DC converter (230) is used as a reference phase, power can be freely transferred among the three bridges through a phase difference between a phase (Φ_{FC_DC}) between the reference phase and a bridge of the hydrogen fuel cell (210) and a phase (Φ_{BAT_DC}) of a bridge of the battery (220).

Referring to FIG. 2, the hydrogen fuel cell (210) is capable of power generation and outputs power only during propulsion operation, and the battery (220) and the propulsion DC/DC converter (230) transfer power during both propulsion operation and regenerative operation.

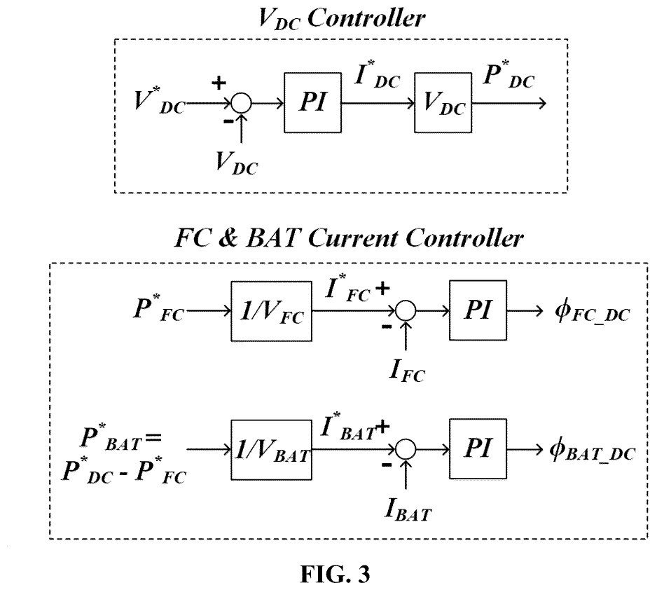

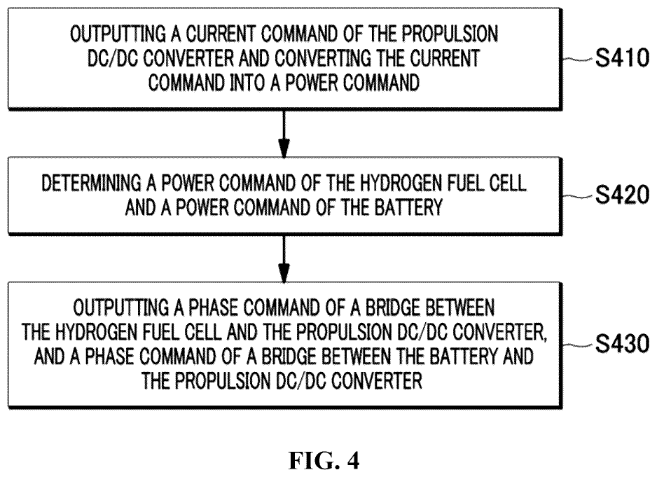

FIG. 3 illustrates a control algorithm of a power conversion apparatus for a hydrogen fuel cell of a hydrogen locomotive according to an embodiment of the present invention, and FIG. 4 is a flowchart illustrating a control method of a power conversion apparatus for a hydrogen fuel cell of a hydrogen locomotive according to an embodiment of the present invention.

According to an embodiment of the present invention, a control system is classified into an upper controller and a lower controller, wherein the upper controller aims to control an input voltage (VDC) of the propulsion DC/DC converter (230), outputs a current command (I*_{DC}) to the lower controller, and the current command is converted into a power command (P*_{DC}) by multiplying by VDC (S410).

A power command (P*_{FC}) of the hydrogen fuel cell (210) is determined based on a V-I curve of the hydrogen fuel cell (210) and railway vehicle operating conditions (S420). The hydrogen fuel cell (210) is capable of outputting power up to rated power during propulsion operation and is controlled to zero during regenerative operation.

A power command (P*_{BAT}) of the battery (220) is determined as a difference between P*_{DC} and P*_{FC} (S420), and outputs of two current controllers output a phase command (Φ_{FC_DC}) of a bridge between the hydrogen fuel cell (210) and the propulsion DC/DC converter (230) and a phase command (Φ_{BAT_DC}) of a bridge between the battery (220) and the propulsion DC/DC converter (230) (S430).

A hydrogen fuel cell-based railway vehicle has different control methods depending on propulsion operation and regenerative operation, and during propulsion operation, control characteristics differ according to a power generation method of the hydrogen fuel cell (210) and the battery (220).

### 1. Propulsion Operation (Hydrogen Fuel Cell and Battery Power Generation)

A hydrogen fuel cell power command (P*_{FC}) is determined according to a V-I curve of the hydrogen fuel cell (210) and railway vehicle operating conditions, and a battery power command (P*_{BAT}) is determined as a difference between a power command (P*_{DC}) of the propulsion DC/DC converter (230) and the hydrogen fuel cell (210) power command (P*_{FC}).

### 2. Propulsion Operation (Hydrogen Fuel Cell Power Generation Only)

Only the hydrogen fuel cell (210) supplies power to the propulsion DC/DC converter (230), the propulsion DC/DC converter (230) is not capable of transferring power exceeding maximum power generation of the hydrogen fuel cell (210) to a propulsion inverter, and the battery (220) does not perform charging or discharging.

### 3. Propulsion Operation (Battery Power Generation Only)

Only the battery (220) supplies power to the propulsion DC/DC converter (230), and when a C-rate of the battery (220) is increased, power can be fully supplied to the propulsion DC/DC converter (230) only by the battery (220), and the hydrogen fuel cell (210) does not generate power.

### 4. Propulsion Operation (Hydrogen Fuel Cell Power Generation and Battery Charging)

When power of the propulsion DC/DC converter (230) is less than rated power of the hydrogen fuel cell (210), the hydrogen fuel cell (210) transfers power to the propulsion DC/DC converter (230) and charges the battery with remaining power.

### 5. Regenerative Operation (Battery Charging Only)

Since the hydrogen fuel cell (210) is capable of power generation only, during regenerative operation, all regenerative energy is charged by the battery (220).

A scenario according to an embodiment of the present invention was performed under conditions as shown in the following [Table 1].

TABLE 1

| Parameter | | Value | |
|---|---|---|---|
| Battery Voltage (V_{BAT}) | | 650 | VDC |
| Battery Rated Power (P_{BAT, rated}) | | 60 | kW |
| Hydrogen Fuel Cell Voltage (V_{FC}) | | 250-450 | V |
| Hydrogen Fuel Cell Rated Power (P_{FC, rated}) | | 65 | kW |
| Propulsion DC/DC Voltage (V_{DC}) | | 650 | VDC |
| Propulsion DC/DC Rated Power (P_{FC, rated}) | | 125 | kW |
| TAB | Switching Frequency (f_{sw}) | 10 | kHz |

| | | |
|---|---|---|
| Converter | Leakage Inductance (L₁, L₂, L₃) | 12 μH, 12 μH, 12 μH |
| | Transformer Turns Ratio (n) | 1:1:1 |

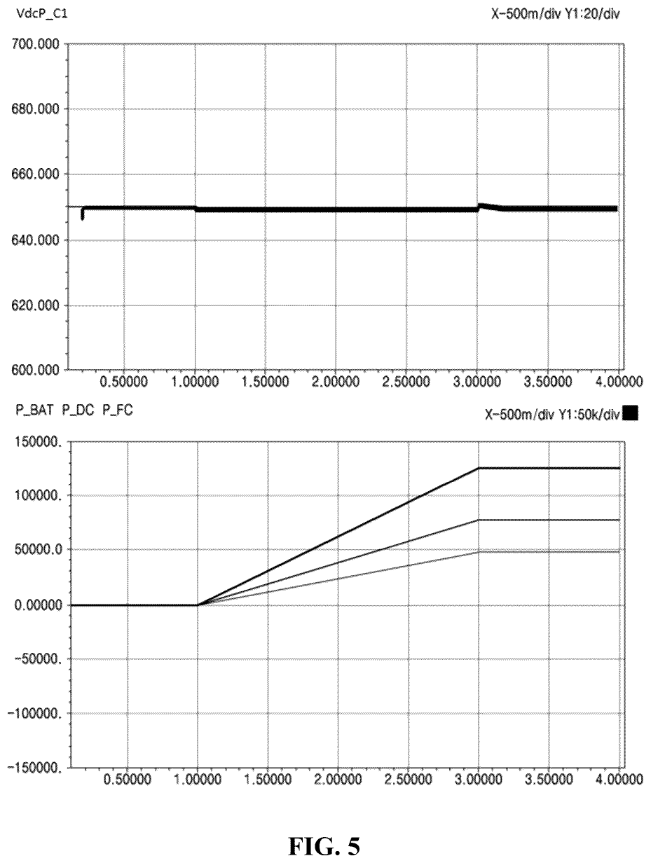

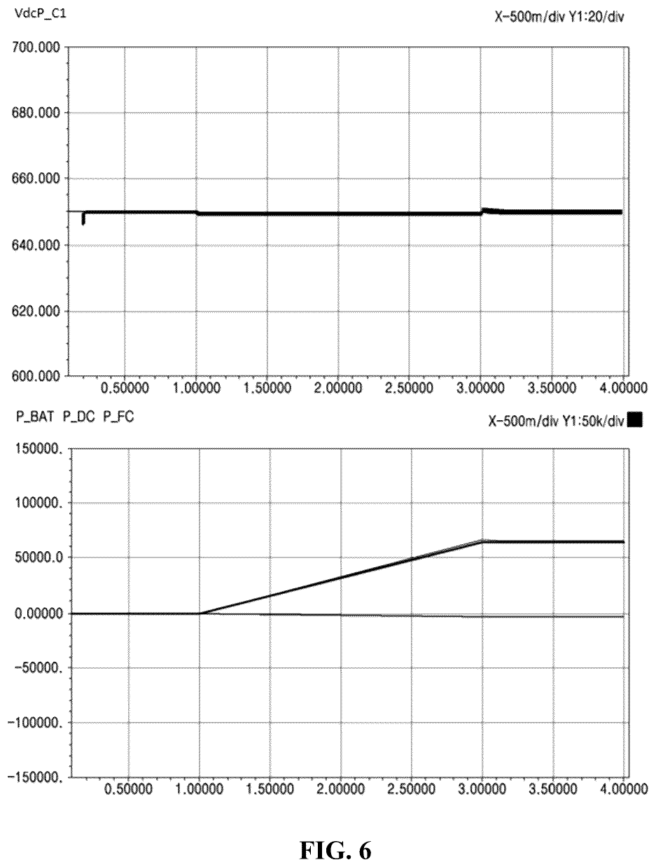

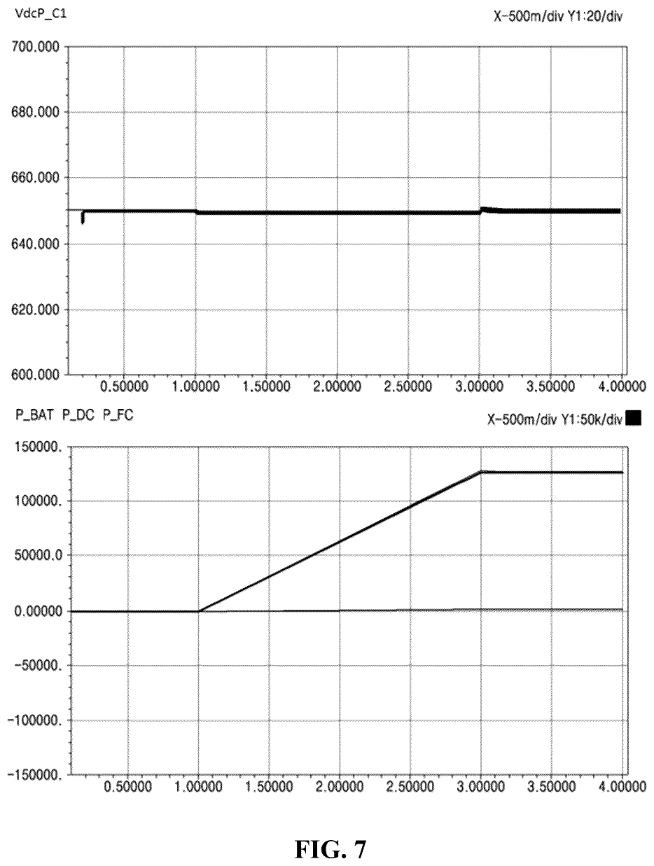

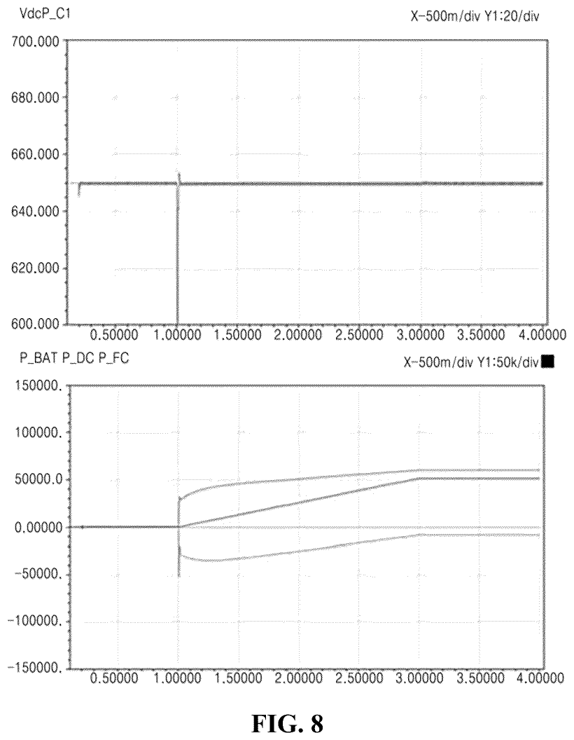

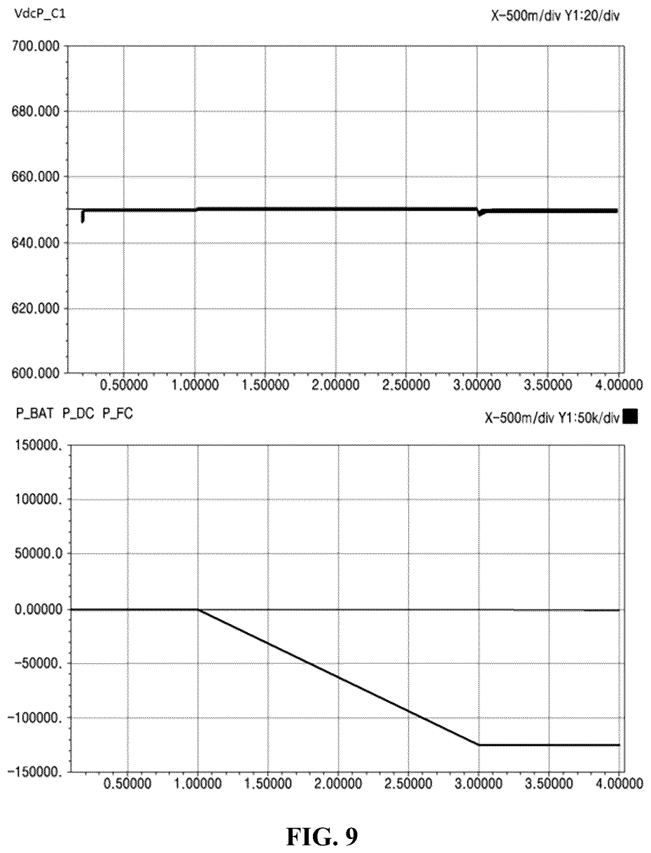

Referring to FIG. 5, FIG. 5 illustrates simulation results of a propulsion operation (hydrogen fuel cell and battery power generation) according to an embodiment of the present invention, FIG. 6 illustrates simulation results of a propulsion operation (hydrogen fuel cell power generation only) according to an embodiment of the present invention, FIG. 7 illustrates simulation results of a propulsion operation (battery power generation only) according to an embodiment of the present invention, FIG. 8 illustrates simulation results of a propulsion operation (hydrogen fuel cell power generation and battery charging) according to an embodiment of the present invention, and FIG. 9 illustrates simulation results of a regenerative operation (battery charging only) according to an embodiment of the present invention.

VdcP_C1 denotes a propulsion DC/DC voltage, P_DC denotes propulsion DC/DC power, P_FC denotes hydrogen fuel cell power generation power, and P_BAT denotes battery power generation power.

### 1. Propulsion Operation (Hydrogen Fuel Cell and Battery Power Generation)

Referring to FIG. 5, in the simulation, a ramp load is applied from 1 s to 3 s, and it is confirmed that both the hydrogen fuel cell and the battery generate power and transfer rated power of 125 kW to the propulsion DC/DC converter.

### 2. Propulsion Operation (Hydrogen Fuel Cell Power Generation Only)

According to railway vehicle operating conditions, a hydrogen fuel cell-based propulsion system should be capable of fuel cell-only power generation. Referring to FIG. 6, through simulation, it can be confirmed that there is no battery power generation and only the hydrogen fuel cell transfers power to the propulsion DC/DC converter.

### 3. Propulsion Operation (Battery Power Generation Only)

Referring to FIG. 7, simulation results in a case where only the battery generates power during propulsion operation are illustrated. It can be confirmed that there is no hydrogen fuel cell power generation and only the battery generates power to transfer power to the propulsion DC/DC converter.

### 4. Propulsion Operation (Hydrogen Fuel Cell Power Generation and Battery Charging)

Referring to FIG. 8, simulation results for hydrogen fuel cell power generation and battery charging are illustrated. It is possible to transfer power required by the propulsion DC/DC converter from the hydrogen fuel cell and to charge the battery by transferring remaining power to the battery, thereby managing a state of charge (SoC).

### 5. Regenerative Operation (Battery Charging Only)

Referring to FIG. 9, simulation results illustrating charging of regenerative power to the battery during regenerative operation are illustrated. During regenerative operation of a railway vehicle, power is transferred from the propulsion DC/DC converter to a hydrogen fuel cell or a battery power source. Since the hydrogen fuel cell is capable of power generation only and cannot receive regenerative power, all regenerative power generated during regenerative operation is transferred to the battery. Through simulation, it can be confirmed that all power of the propulsion DC/DC converter is transferred to the battery.

According to an embodiment of the present invention, the present invention is applicable to a field using a TAB converter, a power conversion apparatus for a hydrogen fuel cell-based railway vehicle, and a field in which a plurality of power generation sources are provided.

A control method of a power conversion apparatus for a hydrogen fuel cell of a hydrogen locomotive according to an embodiment of the present invention is performed by a power conversion control system for a hydrogen fuel cell of a hydrogen locomotive.

The control method of the power conversion apparatus for a hydrogen fuel cell of a hydrogen locomotive, which is performed by the power conversion control system for a hydrogen fuel cell of a hydrogen locomotive according to an embodiment of the present invention, includes: (a) configuring a power conversion apparatus for a hydrogen fuel cell of a hydrogen locomotive including a TAB converter; and (b) controlling the power conversion apparatus to transfer power during propulsion operation or regenerative operation.

The step (a) configures a TAB converter including a bridge between a hydrogen fuel cell and a propulsion DC/DC converter, and a bridge between a battery and the propulsion DC/DC converter.

The step (b) outputs a current command of the propulsion DC/DC converter, converts the current command into a power command, determines a power command of the hydrogen fuel cell based on a V-I curve of the hydrogen fuel cell and railway vehicle operating conditions, determines a difference between the power command of the propulsion DC/DC converter and the power command of the hydrogen fuel cell as a power command of the battery, and outputs a phase command of the bridge between the hydrogen fuel cell and the propulsion DC/DC converter and a phase command of the bridge between the battery and the propulsion DC/DC converter.

In the step (b), during a propulsion operation in which only the hydrogen fuel cell generates power, the battery does not perform charging or discharging.

In the step (b), during a propulsion operation in which only the battery generates power, power is supplied to the propulsion DC/DC converter through adjustment of a C-rate of the battery.

In the step (b), during a propulsion operation in which power of the propulsion DC/DC converter is less than rated power of the hydrogen fuel cell, the hydrogen fuel cell transfers power to the propulsion DC/DC converter and charges the battery with remaining power.

In the step (b), during regenerative operation, regenerative power of the DC/DC converter is entirely transferred to the battery.

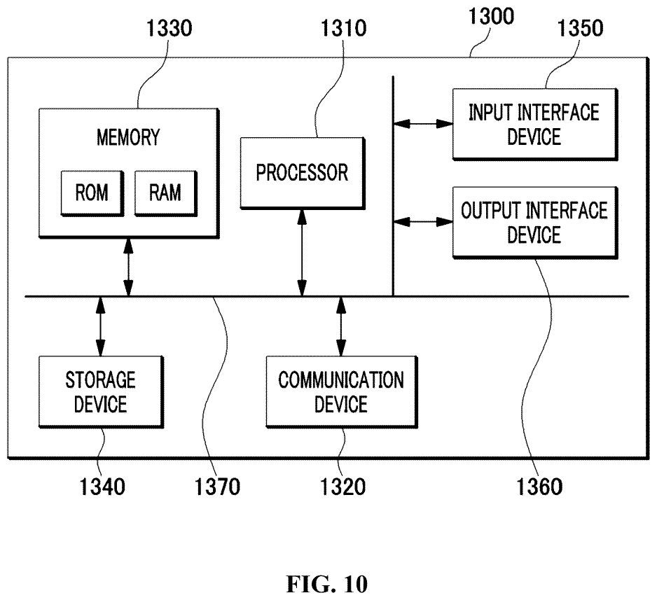

FIG. 10 is a block diagram illustrating a computer system for implementing a method according to an embodiment of the present invention.

Referring to FIG. 10, a computer system (1300) may include at least one of a processor (1310), a memory (1330), an input interface device (1350), an output interface device (1360), and a storage device (1340) that communicate with each other through a bus (1370). The computer system (1300) may further include a communication device (1320) coupled to a network. The processor (1310) may be a central processing unit (CPU) or a semiconductor device that executes instructions stored in the memory (1330) or the storage device (1340). The memory (1330) and the storage device (1340) may include various types of volatile or non-volatile storage media. For example, the memory may include a read-only memory (ROM) and a random access memory (RAM). In the present embodiment, the memory may be located inside or outside the processor, and the memory may be connected to the processor through various known means. The memory is a volatile or non-volatile storage medium, and for example, the memory may include a read-only memory (ROM) or a random access memory (RAM).

Accordingly, an embodiment of the present invention may be implemented as a computer-implemented method or as a non-transitory computer-readable medium storing computer-executable instructions. In one embodiment, when executed by a processor, the computer-readable instructions may perform a method according to at least one aspect of the present disclosure.

The communication device (1320) may transmit or receive a wired signal or a wireless signal.

In addition, the method according to an embodiment of the present invention may be implemented in the form of program instructions executable through various computer means, and may be recorded on a computer-readable medium.

The computer-readable medium may include program instructions, data files, data structures, or a combination thereof. The program instructions recorded on the computer-readable medium may be specially designed and configured for an embodiment of the present invention or may be known and available to those skilled in the art of computer software. The computer-readable recording medium may include a hardware device configured to store and execute program instructions. For example, the computer-readable recording medium may include magnetic media such as a hard disk, a floppy disk, and a magnetic tape, optical recording media such as a CD-ROM and a DVD, magneto-optical media such as a floptical disk, and a ROM, a RAM, and a flash memory. The program instructions may include machine language code generated by a compiler as well as high-level language code executable by a computer through an interpreter or the like.

Although embodiments of the present invention have been described in detail above, the scope of the present invention is not limited thereto, and various modifications and improvements made by those skilled in the art using the basic concept of the present invention as defined in the following claims also fall within the scope of the present invention.

What is claimed is:

1. An apparatus for power conversion for a hydrogen fuel cell of a hydrogen locomotive, comprising a TAB (Triple-Active-Bridge) converter, wherein a hydrogen fuel cell and a battery are electrically isolated.

2. The apparatus of claim 1,
wherein the TAB converter includes a bridge (a second bridge) between the hydrogen fuel cell and a propulsion DC/DC converter, and a bridge (a third bridge) between the battery and the propulsion DC/DC converter.

3. The apparatus of claim 2,
wherein the TAB converter transfers power between bridges based on a phase difference between a phase of the second bridge and a phase of the third bridge, with reference to a phase of a reference bridge connected to the propulsion DC/DC converter.

4. A control method of a power conversion apparatus for a hydrogen fuel cell of a hydrogen locomotive, which is performed by a power conversion control system for a hydrogen fuel cell of a hydrogen locomotive,
comprising:
(a) configuring a power conversion apparatus for a hydrogen fuel cell of a hydrogen locomotive including a TAB converter; and
(b) controlling the power conversion apparatus to transfer power during propulsion operation or regenerative operation.

5. The control method of a power conversion apparatus for a hydrogen fuel cell of a hydrogen locomotive of claim 4,
wherein the step (a) configures the TAB converter including a bridge between the hydrogen fuel cell and the propulsion DC/DC converter, and a bridge between the battery and the propulsion DC/DC converter.

6. The control method of claim 5,
wherein the step (b) outputs a current command of the propulsion DC/DC converter, converts the current command into a power command, determines a power command of the hydrogen fuel cell based on a V-I curve of the hydrogen fuel cell and railway vehicle operating conditions, determines a difference between the power command of the propulsion DC/DC converter and the power command of the hydrogen fuel cell as a power command of the battery, and outputs a phase command of a bridge between the hydrogen fuel cell and the propulsion DC/DC converter and a phase command of a bridge between the battery and the propulsion DC/DC converter.

7. The control method of claim 6,
wherein, in the step (b), during a propulsion operation in which only the hydrogen fuel cell generates power, the battery does not perform charging or discharging.

8. The control method of claim 6,
wherein, in the step (b), during a propulsion operation in which only the battery generates power, power is supplied to the propulsion DC/DC converter through adjustment of a C-rate of the battery.

9. The control method of claim 6,
wherein, in the step (b), during a propulsion operation in which power of the propulsion DC/DC converter is less than rated power of the hydrogen fuel cell, the hydrogen fuel cell transfers power to the propulsion DC/DC converter and charges the battery with remaining power.

10. The control method claim 6,
wherein, in the step (b), during regenerative operation, regenerative power of the DC/DC converter is entirely transferred to the battery.
